(19) United States
(12) Patent Application Publication
(10) Pub. No.: US 2022/0180403 A1
(43) Pub. Date: Jun. 9, 2022

(54) SECURE COMMUNICATION METHOD SUITABLE FOR ORDERING A PRODUCT OR A SERVICE USING A COMMUNICATION TERMINAL

(71) Applicant: Orange, Issy-les-Moulineaux (FR)

(72) Inventors: Fabrice Jeanne, Châtillon Cedex (FR); Romain Trinquart, Châtillon Cedex (FR); Sandrine Le Calvez, Châtillon Cedex (FR)

(21) Appl. No.: 17/600,533

(22) PCT Filed: Mar. 20, 2020
(86) PCT No.: PCT/FR2020/050610

§ 371 Date: Sep. 30, 2021

(30) Foreign Application Priority Data
Apr. 1, 2019 (FR) 1903440

(51) Int. Cl. G06Q 30/02; H04L 9/40

(52) U.S. Cl. CPC G06Q 30/0267; H04L 63/0421

(57) ABSTRACT

A secure communication method for ordering a product or a service by way of a communication terminal is described. The method is performed by the terminal and includes sending, to a server, a request containing information relating to a product or to a service, establishing, in the background, a communication to N supplier terminals (N≥1) identified by the server as being able to supply the product or the service, based on all or some of the information in the request, the communication being established while masking the communication identifier of the terminal and of the N terminals, and, in the course of the communication, receiving, from at least one supplier terminal out of at least K supplier terminals, such that 1≤K≤N, an offer for a product or for a service corresponding to the information, the offer having been generated during the communication.

### FIELD OF THE INVENTION

The present invention relates in general to the field of secure communications, in particular in the context of ordering a product or a service using a communication terminal (mobile telephone, tablet, computer, etc.).

### PRIOR ART

At present, to order a product or a service using a communication terminal, the user enters information relating to the product or to the service into a search engine. Such information describes the product or the service that the user wishes to order, and possibly includes the cost for which the user wishes to acquire the product or the service. A search is then launched on the basis of the entered information and, in return, the user's terminal displays a list of providers capable of offering the user the product or the service corresponding to the entered information.

The drawback of this type of ordering method lies in the fact that the user then has to navigate through the received list of providers, and establish contact with each of them in order to ascertain whether the providers are actually able to fulfil the order. Such an ordering method is tedious and time-consuming for the user. It is also unreliable, considering the fact that the search itself is generally highly approximative.

Another drawback of this type of method is that personal data relating to providers are disclosed in the received list of providers. Providers are therefore not protected from being contacted by a malicious user, for example when the cost of the required product or service is high. The fact that the user contacts a provider from the list also has the drawback of disclosing the user's personal data to said provider (for example: the user's name or telephone number displayed on the provider's communication terminal), even though the order for the product or service has not yet even been finalized.

In order to simplify this type of ordering method and obtain a more targeted list of providers in relation to the search criteria entered by the user, some online sales sites now give the user the option to filter the results of a search for a product or service that the user wishes to order, based on the location of a communication terminal of the user. Such filtering does make it possible to reduce the list of potential providers of the product or service. However, the user is still obliged to contact the providers from the list one by one, and the disclosure of the user's personal data, like those of the providers, is still not preserved.

### AIM AND SUMMARY OF THE INVENTION

One of the aims of the invention is to rectify drawbacks of the abovementioned prior art.

To this end, one subject of the present invention relates to a method for ordering a product or a service by way of a communication terminal associated with a communication identifier.

Such a method is noteworthy in that it comprises the following, at the level of the terminal:
sending, to a server, a request to order the product or the service, said request containing information relating to the product or to the service,
establishing, in the background, communication to N terminals associated, respectively, with N communication identifiers (N≥1), the N terminals being terminals of providers identified by the server as being able to provide the product or the service on the basis of all or some of the information contained in the request, said communication being established while masking the communication identifier of the terminal and the N communication identifiers,
during the communication, receiving an offer for the product or the service from at least one provider terminal from among at least K, such that 1≤K≤N, the offer having been generated during the communication and selected so as to optimize a compromise between firstly all or some of the information contained in the request, and secondly an item of location data of the communication terminal and/or an item of time data associated with the request,
commanding the rendering of the offer, the communication identifier of said at least one provider terminal and the identification of the provider of said at least one provider terminal being masked during the rendering.

Such a method for ordering a product or service is particularly simple and quick to implement for the user, since said user simply sends a request to a server using his terminal in order to specify the information relating to the product or to the service that he wishes to order.

Advantageously, the user also does not need to contact the N providers of the product or service that he wishes to obtain one by one, such contacting being executed in the background or as a background task on the initiative of the user's terminal. As a result, the method for ordering a product or service is easier to use and is performed far more quickly than in the prior art.

Another advantage of such a method is that it preserves the confidentiality of personal data both on the side of the terminal that requested the product or service offer and on the side of the N terminals of product or service providers that have been identified.

According to one particular embodiment, the method comprises the following, in the event of the offer being accepted:
sending identification data of the user of the terminal to said at least one provider terminal,
receiving identification data of the user of said at least one provider terminal.

By virtue of such an embodiment, the anonymity of the user of the communication terminal and the anonymity of the provider of the product or of the service for which the offer has been accepted are lifted only once the offer has been accepted by the user of the terminal.

According to another particular embodiment, the method comprises the following, in the event of the offer being declined:
continuing the communication, during which the actions of receiving an offer and of commanding the rendering of the received offer are iterated for as long as an offer is not accepted.

Such an embodiment makes it possible to offer the user of the terminal one or more other product or service offers that correspond to his search criteria, even if said user has declined the optimum offer, without the user needing to contact the various product or service providers on his own initiative. In addition, since the identities of the providers are not known to the user, such an embodiment makes it possible to protect providers, in particular when the information contained in the request is sensitive, such as for example a high cost of the required product or service, a rare item, etc.

According to another particular embodiment, during the communication, the terminal receives, from respectively N-K product or service provider terminals identified by the server, N-K declinations to provide the product or the service corresponding to the request.

Such an embodiment advantageously allows the user of the terminal who sent the request to order the product or the service to receive only offers from the remaining K providers with an interest in the ordered product or service. This results in a reduction in the exchanges that will be likely to take place during the communication between the user's terminal and the remaining K provider terminals, thereby limiting the congestion of the communication network between the user's terminal and the provider terminals. Given the fact that the communication is established in the background and that the identity of the providers and of their corresponding communication terminals is not known to the user, it is advantageously not possible for the user to identify the N-K providers that declined to provide the product or the service corresponding to the request.

According to another particular embodiment, the product or service offer received during the communication is generated taking into account at least one adjustment variable for:
all or some of the information contained in the request, and/or
an item of location data of the communication terminal, and/or
an item of time data associated with the request.

The advantage of such an embodiment is that the user of the terminal receives at least one product or service offer, even if said offer does not correspond exactly to the information relating to the product or service mentioned in the request and/or to the location of the terminal and/or to the date/time at which the request was sent and/or to time information indicated in the request.

The various abovementioned embodiments or implementation features may be added, independently or in combination with one another, to the method for ordering a product or service defined above.

The invention also relates to a communication terminal for ordering a product or a service, said communication terminal being associated with a communication identifier.

Such a terminal is noteworthy in that it comprises a processor that is configured so as to implement the following:
sending, to a server, a request to order the product or the service, said request containing information relating to the product or to the service,
establishing, in the background, communication to N terminals associated, respectively, with N communication identifiers (N≥1), the N terminals being terminals of providers identified by the server as being able to provide the product or the service on the basis of all or some of the information contained in the request, said communication being established while masking the communication identifier of the terminal and the N communication identifiers,
during the communication, receiving an offer for the product or the service from at least one provider terminal from among at least K, such that 1≤K≤N, the offer having been generated during the communication and selected so as to optimize a compromise between firstly all or some of the information contained in the request, and secondly an item of location data of the communication terminal and/or an item of time data associated with the request,
commanding the rendering of the offer on a rendering interface, the communication identifier of said at least one provider terminal and the identification of the provider of said at least one provider terminal being masked during the rendering.

Such a communication terminal is in particular able to implement the abovementioned method for ordering a product or service.

The invention also relates to a computer program comprising instructions for implementing the method for ordering a product or service according to the invention according to any one of the particular embodiments described above when said program is executed by a processor.

Such instructions may be stored durably in a non-transient memory medium of the communication terminal.

This program may use any programming language and be in the form of source code, object code or intermediate code between source code and object code, such as in a partially compiled form, or in any other desirable form.

The invention also targets a computer-readable storage medium or information medium containing instructions of a computer program, such as mentioned above.

The storage medium may be any entity or device capable of storing the program. For example, the medium may contain a storage means, such as a ROM, for example a CD-ROM or a microelectronic circuit ROM, or else a magnetic storage means, for example a USB key or a hard drive.

Moreover, the storage medium may be a transmissible medium such as an electrical or optical signal, which may be conveyed via an electrical or optical cable, by radio or by other means. The program according to the invention may in particular be downloaded from an Internet network.

As an alternative, the recording medium may be an integrated circuit in which the program is incorporated, the circuit being designed to execute or to be used in the execution of the abovementioned method for ordering a product or service.

### BRIEF DESCRIPTION OF THE DRAWINGS

Other features and advantages will become apparent on reading particular embodiments of the invention, which are given by way of illustrative and non-limiting example, and the appended drawings, in which:

FIG. 1 is a schematic and general view of an architecture in which the method for ordering a product or service is implemented, in one particular embodiment of the invention,

FIG. 2 shows a communication terminal for ordering a product or a service, in one particular embodiment of the invention,

FIG. 3 shows the main actions implemented in the method for ordering a product or service according to one particular embodiment of the invention.

### DETAILED DESCRIPTION OF ONE EMBODIMENT OF THE INVENTION

### Architectural Environment

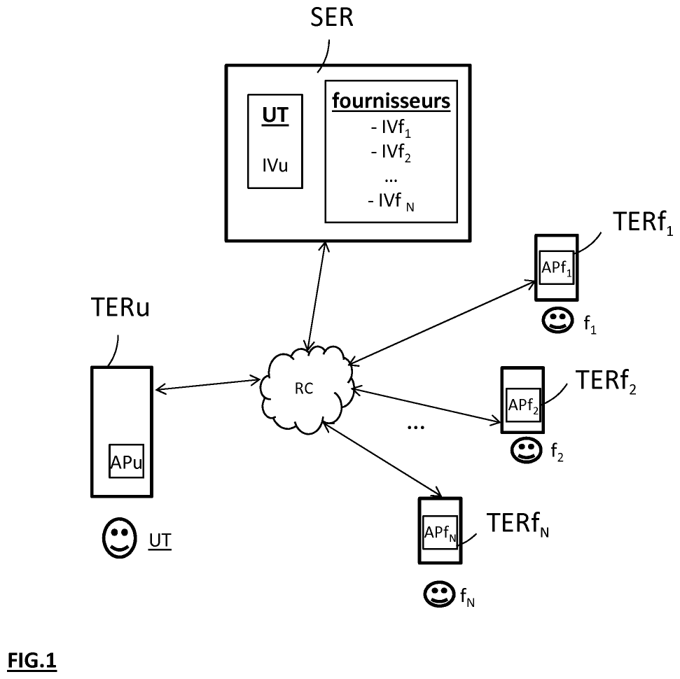

FIG. 1 shows an environment in which the method for ordering a product or service according to the invention is implemented.

FIG. 1 shows:
a communication terminal TERu of a user UT wishing to order a product or a service,
N communication terminals TERf₁, TERf₂, . . . , TERf_{N} belonging, respectively, to N product or service providers f₁, f₂, . . . , f_{N},
a server SER for establishing a connection between the terminal TERu and each of the provider communication terminals TERf₁, TERf₂, . . . , TERf_{N}.

The terminal TERu, the terminals TERf₁, TERf₂, . . . , TERf_{N} and the server SER communicate with one another via a communication network RC. This may for example be an IP (abbreviation for “Internet Protocol”) network, an x-DSL network, fiber network or even 3G, 4G, 5G, etc. network.

By way of non-exhaustive example, the terminal TERu and the terminals TERf₁, TERf₂, . . . , TERf_{N} are:
a cellphone, and/or
a smartphone, and/or
a tablet, and/or
a laptop, and/or
a personal computer of PC type, and/or
etc.

The terminal TERu is conventionally associated with a communication identifier ICu, such as for example the mobile telephone number, the landline number, the IP address or else the permanent email address of the user UT, such an identifier having been assigned thereto by one or more telecommunications operators to which the user UT has subscribed or even by one or more telecommunications service providers with which the user UT has created an account.

For one provider terminal TERfᵢ (1≤i≤N) under consideration from among N, the terminal TERfᵢ is conventionally associated with a communication identifier ICfᵢ, such as for example the mobile telephone number, the landline number, the IP address or else the permanent email address of the provider fᵢ, such an identifier having been assigned thereto by one or more telecommunications operators to which the provider fᵢ has subscribed or even by one or more telecommunications service providers with which the provider fᵢ has created an account.

The terminal TERu comprises a software application (or application program) APu that is dedicated to implementing the method for ordering a product or service in accordance with the present invention. The application APu is downloaded onto the terminal TERu, before the execution of the method for ordering a product or service. The provider terminals TERf₁, TERf₂, . . . , TERf_{N} also each comprise a corresponding software application (or application program) APf₁, APf₂, . . . , APf_{N} that is able to dialog with the application APᵤ when implementing the method for ordering a product or service in accordance with the present invention. The applications APf₁, APf₂, . . . , APf_{N} are respectively downloaded onto the provider terminals TERf₁, TERf₂, . . . , TERf_{N}, before the execution of the method for ordering a product or service.

The server SER stores the following in a memory or a database:
a virtual communication identifier IVu assigned to the user UT, such an identifier being associated with the communication identifier ICu of the terminal TERu,
virtual communication identifiers IVf₁, IVf₂, . . . , IVf_{N} relating, respectively, to the providers f₁, f₂, . . . , f_{N}, such identifiers being associated, respectively, with the communication identifiers ICf₁, ICf₂, . . . , ICf_{N}.

A virtual communication identifier is for example a sequence of numeric or alphanumeric characters, generated for example randomly. The virtual identifier of the user UT (respectively of one provider fᵢ under consideration from among N) is intended to be transmitted in the communication network RC instead of the communication identifier ICu (respectively the communication identifier ION in order to preserve the anonymity of the user UT (respectively of the product or service provider fᵢ).

### Description of One Embodiment of the Communication Terminal TERu

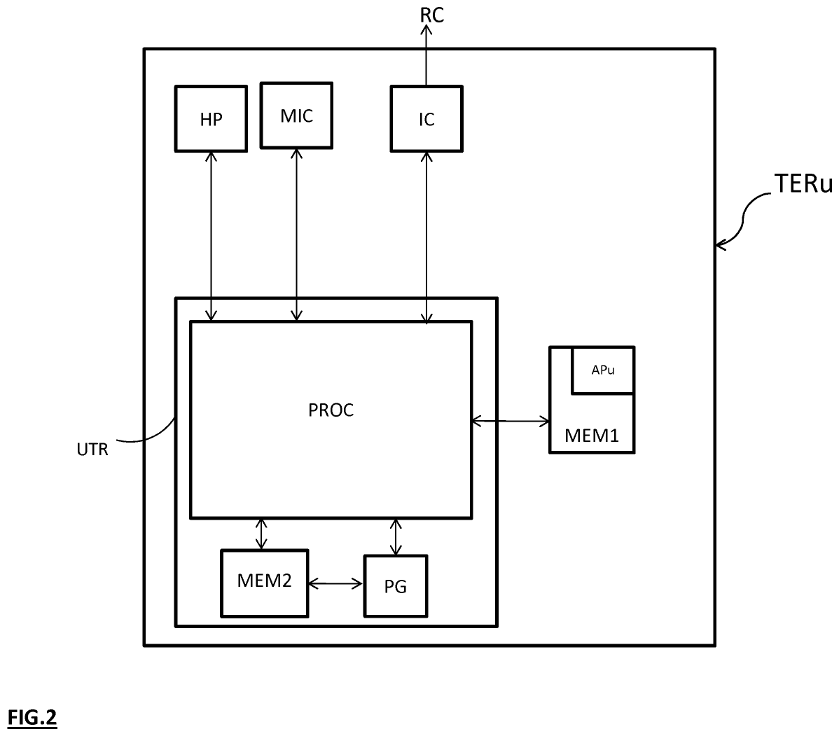

FIG. 2 shows the simplified structure of the communication terminal TERu designed to implement the method for ordering a product or service that will be described below.

In a manner known per se, the communication terminal TERu comprises:
a connection interface IC that is designed to communicate with the server SER of FIG. 1 via the communication network RC, in accordance for example with the http (abbreviation for “HyperText Transfer Protocol”) protocol,
a display screen EC,
a loudspeaker HP,
a microphone MIC.

According to the invention, the terminal TERu stores, in a memory MEM1, the application APu dedicated to executing the method for ordering a product or service according to the invention.

According to one particular embodiment of the invention, the actions executed by the method for ordering a product or service are implemented by instructions of a computer program PG. To this end, the terminal TERu has the conventional architecture of a computer and comprises in particular a memory MEM2, a processing unit UTR, equipped for example with a processor PROC, and driven by the computer program PG stored in memory MEM2. The computer program PG comprises instructions for implementing the actions of the method for ordering a product or service that will be described below, when the program is executed by the processor PROC, according to any one of the particular embodiments of the invention.

On initialization, the code instructions of the computer program PG are for example loaded into a RAM memory (not shown), before being executed by the processor PROC. The processor PROC of the processing unit UTR implements in particular the actions of the method for ordering a product or service, according to the instructions of the computer program PG.

### Description of One Embodiment of the Method for Ordering a Product or Service

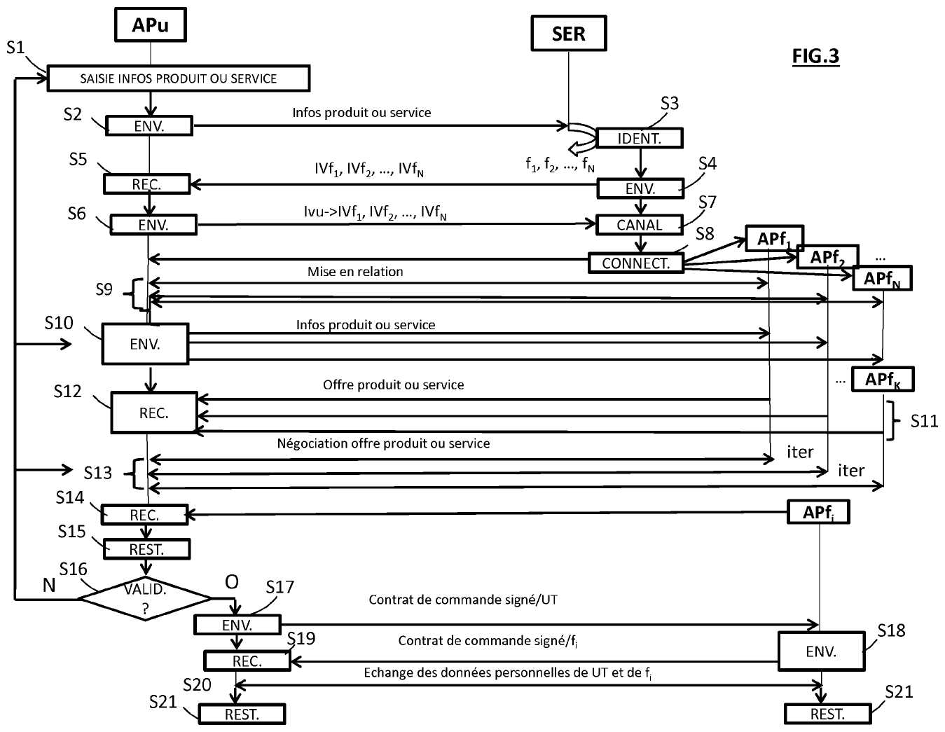

With reference to FIG. 3, a description is now given of the sequence of a method for ordering a product or service according to one embodiment of the invention. According to a first exemplary embodiment, the user UT, in the context of an electronic wallet service, wishes to withdraw cash using his terminal TERu in a partner merchant.

According to a second exemplary embodiment, the user wishes to purchase an automobile of make X, model Y and color Z.

At S1, the user UT opens the application APu and uses a user interface generated by the application APu to enter information relating to the product or to the service that the user wishes to order. Such a user interface may be a voice interface rendered via the loudspeaker HP in FIG. 2, or else be a text interface rendered on the screen EC in FIG. 2.

In the case of the first exemplary embodiment, the information relating to the product or to the service comprises the amount that the user UT wishes to withdraw, that is to say t euros.

In the case of the second exemplary embodiment, the information relating to the product or to the service comprises the type of product: “automobile”, the price, the make X, the model Y and the color Z of the desired automobile. Of course, such information could be limited to the word “automobile” or to a combination of the word “automobile” with one and/or the other of the categories “price”, make X, model Y, color Z.

The information relating to the product or service may also comprise:
an item of location data of the terminal TERu, such as for example the GPS (abbreviation for “Global Positioning System”) coordinates of the terminal TERu; and/or
one or more items of time data associated with the request, such as:
one or more items of time data relating to the entry, for example the date of the entry, the time of the entry in hours, minute(s), second(s),
one or more items of time data relating to the sending of the request, such as for example timestamp data,
one or more items of time data relating to the provision of the desired product or service, such as for example a day of the week or of the current month, a time slot during the day, 9:30 a.m. to 12:30 p.m., for example.

Optionally, the information relating to the required product or service furthermore comprises one or more adjustment variables for:
all or some of the information contained in the request, and/or
an item of location data of the communication terminal, and/or
at least one of the abovementioned items of time data associated with the request.

If for example an item of information contained in the request is a price of the product or of the service, an adjustment variable consists for example of a tolerance range in regard to this price, for example plus or minus 5%, 10%, etc.

If for example an item of information contained in the request is an item of location data, such as a distance of j kilometers around the communication terminal, an adjustment variable consists for example of a tolerance range in regard to this distance, for example j plus or minus 500 m, 1 km, etc.

If for example an item of information contained in the request is at least one item of time data, an adjustment variable consists for example of a variation of a time slot initially mentioned in the request or else a period of validity of the order for the desired product or service, for example 1 day, 2 days, 1 week, etc.

At S2, a request to order a product or service, containing the entered information, is sent to the server SER by way of the application APu via the network RC of FIG. 1. Such sending may be implemented by way of a button generated by the user interface of the application APu and rendered on the screen EC, or by way of a voice command generated by the user interface of the application APu and rendered by the loudspeaker HP. The request that is sent complies for example with the http or https protocol.

At S3, the server SER receives the request. It then identifies the N providers f₁, f₂, . . . , f_{N} as being able to provide the requested product or service. Such identification is implemented using a data analysis mechanism that uses all or some of the information relating to the product or to the service contained in the request sent at S2 and that calculates a probability of the N providers f₁, f₂, . . . , f_{N} being able to provide the required product or service. The probability is possibly calculated on the basis of a local history accessible to the server SER.

In the case of the first exemplary embodiment, the server SER thus assesses, based on the transactions already carried out by the providers f₁, f₂, . . . , f_{N} and stored in a local history, that they are capable of providing the amount of t euros requested by the user UT.

In the case of the second exemplary embodiment, the server SER is able to evaluate, based on the local history, that a particular automobile required by the user UT is in stock at all of the providers f₁, f₂, . . . , f_{N}.

Such identification makes it possible, in a manner completely transparent to the user UT and in a dynamic and targeted manner, to obtain a list of providers for which there is a high probability that they will be able to respond favorably to the request to order a product or service sent at S2.

At S4, the server SER sends a response to the received request to the application APu. Such a response contains the virtual identifiers IVf₁, IVf₂, . . . , IVf_{N} relating, respectively, to the providers f₁, f₂, . . . , f_{N}.

Optionally, the virtual identifiers IVf₁, IVf₂, . . . , IVf_{N} sent at S4 are associated, respectively, with the probabilities, calculated by the server SER, of the N providers f₁, f₂, . . . , f_{N} being able to provide the required product or service.

At S5, the application APu receives the response.

At S6, a request requesting to communicate with the provider terminals TERf₁, TERf₂, . . . , TERf_{N} is then sent by the application APu to the server SER in the background, said request containing the virtual identifier IVu of the terminal TERu and the virtual identifiers IVf₁, IVf₂, . . . , IVf_{N} relating, respectively, to the providers f₁, f₂, . . . , f_{N}.

At S7, the server SER receives the request and then creates an anonymized exchange channel for establishing a connection in peer-to-peer mode between the application APu of the terminal TERu and each of the applications APf₁, APf₂, . . . , APf_{N} of the provider terminals TERf₁, TERf₂, . . . , TERf_{N}.

At S8, the server SER sends a connection establishment request to each of the applications APu and APf₁, APf₂, . . . , APf_{N}.

At S9, the communication between the application APu and each of the applications APf₁, APf₂, . . . , APf_{N} is then established, after validation with the server SER, by the applications APu and APf₁, APf₂, . . . , APf_{N}, of the connection establishment request. The communication is established for example by way of a synchronous or asynchronous bidirectional communication protocol, such as for example WebSocket, http, etc.

Particularly advantageously, the communication is implemented in the background, and therefore in a manner transparent to the user UT. Moreover, the abovementioned public communication identifiers ICu and ICf₁, ICf₂, . . . , ICf_{N} are masked during the communication, since they are replaced, respectively, with the abovementioned virtual identifiers IVu, IVf₁, IVf₂, . . . , IVf_{N}.

At S10, the application APu sends the request previously sent at S2, in the background, to each of the applications APf₁, APf₂, . . . , APf_{N}. Said request may contain, in addition to the information already mentioned in relation to the above operation S2, one or more adjustment variables for:
all or some of the information contained in the request, and/or
an item of location data of the communication terminal, and/or
an item of time data associated with the request, such as for example the date of the entry, the time of the entry in hours, minute(s), second(s), a day of the week or of the current month, a time slot during the day, 9:30 a.m. to 12:30 p.m., for example.

In the case of the abovementioned first exemplary embodiment, the adjustment variable may for example consist of a tolerance of plus or minus 5% of the requested amount of t euros.

In the case of the abovementioned second exemplary embodiment, the adjustment variable may for example consist of a tolerance in regard to the color Z initially entered.

Each of the provider terminals TERf₁, TERf₂, . . . , TERf_{N} then assesses, locally if it is able to do so, at the time when it receives the request sent at S10, whether the identified providers f₁, f₂, . . . , f_{N} are able to respond favorably to the request, on the basis of all or some of the information contained in this request, the adjustment variables contained in this request and/or possibly adjustment variables exchanged during said communication between the application APu and each of the applications APf₁, APf₂, . . . , APf_{N} and/or any adjustment variables already accepted by the service providers. Such an estimate is established by calculating probabilities considering, at input, the information contained in this request and the abovementioned adjustment variables.

According to the abovementioned first exemplary embodiment, the estimate is based for example:
only on the amount of t euros mentioned in the request sent at S10;
on the amount of t euros and on an item of location data of the terminal TERu, such as for example a radius of j kilometers around the terminal TERu;
on the amount of t euros, and/or on an item of location data of the terminal TERu, such as for example a radius of j kilometers around the terminal TERu, and/or an adjustment variable of plus or minus 5% of the amount of t euros.

According to the abovementioned second exemplary embodiment, the estimate is based for example:
only on the type of product: “automobile”, the price, the make X, the model Y and the color Z of the desired automobile;
on the type of product: “automobile”, the price, the make X, the model Y and the color Z of the desired automobile and/or on an item of location data of the terminal TERu, such as for example a radius of j kilometers around the terminal TERu, and/or an adjustment variable in regard for example to the color Z. If the color Z is blue, for example, the estimate is calculated taking into account another color, for example the color gray and/or the color black.

At the end of this estimate, N-K providers, such that K≤N, may abandon the communication because either they do not have the desired product or they cannot provide the desired service under the conditions accepted by these providers with regard to the conditions desired by the user UT. To this end, the application APu receives (not shown in FIG. 3) N-K messages declining to provide the desired product or service from the N-K corresponding applications of the N-K provider terminals K+1, . . . , N.

At S11, K applications APf₁, APf₂, . . . , APf_{K} each send a response to the application APu, each response containing the conditions of the offer that the corresponding provider f₁, f₂, . . . , f_{K} is able to make, which are based on the calculation of the above estimate.

At S12, the application APu receives each of the K responses containing, respectively, K offers for the required product or service in the background.

At S13, a phase of negotiation between the application APu and each of the K applications APf₁, APf₂, . . . , APf_{K} is then implemented in the background, so as to select at least one optimum product or service offer. This offer is selected so as to optimize a compromise between firstly all or some of the information contained in the request sent at S10, and secondly at least one item of location data of the communication terminal TERu, as described above, and/or at least one item of time data associated with the request sent at S10, some examples of which have already been described above, and/or else at least one adjustment variable as described above. During the negotiation, for each offer sent to the application APu by one application APfᵢ under consideration from among K, the application APu responds to the offer by returning either a declination message or an acceptance message to the application APfᵢ under consideration. This exchange is iterated for 1≤i≤K. The optimum offer is for example the one sent by the application APfᵢ of the provider terminal TERfᵢ.

All of the offers to which the application APu has responded favorably may be ranked in order from the optimum offer to the least optimum offer.

At S14, the application APu receives the optimum product or service offer in the background.

At S15, the rendering of the optimum offer on for example a rendering interface of the terminal TERu, such as for example the screen EC or the loudspeaker HP of FIG. 2, is commanded. According to one exemplary embodiment, an icon anonymously representing the provider fᵢ is displayed on a map of the location where the provider fᵢ is located, thereby allowing the user UT to roughly locate the location of the provider fᵢ. Particularly advantageously, no personal information about the provider fᵢ, be this his name, his address, the communication identifier ICfᵢ of the provider terminal TERfᵢ, etc., is displayed on the screen EC. According to another example, a statement such as: “the provider fᵢ is 5 km north-west from your home” is uttered via the loudspeaker HP. Such a statement does not disclose any personal information about the provider fᵢ, be this his name, his address, the communication identifier ICfᵢ of the provider terminal TERfᵢ, etc.

At S16, if the user UT confirms the offer (“Y” in FIG. 3), for example by pressing a dedicated button on the screen EC or by saying “OK” via the microphone MIC in FIG. 2, a contract for the offer for the desired product or service is generated by the application APu according to preprogrammed parameters, such a contract being considered to be signed by the user UT, but not at this stage comprising any personal data relating to the user UT.

At S17, the contract signed by the user UT is sent by the application APu to the application APfᵢ in the background.

The terminal TERfᵢ receives the contract and, if it is confirmed by the provider fᵢ according to the same principles as those implemented for the user UT, the generation of a contract signature by the provider fᵢ is triggered via the application APfᵢ. At this stage, the contract does not comprise any personal data relating to the provider fᵢ either.

At S18, the contract signed by the provider fᵢ is sent by the application APfᵢ to the application APu in the background.

At S19, the terminal TERu receives the contract signed by the provider fᵢ.

At S20, personal data relating to the user UT are sent to the terminal TERfᵢ in the background according to a predefined configuration. At the end of this sending, and according to this predefined configuration, the personal data of the user UT are rendered on the terminal TERfᵢ, in text or voice form, at S21. These may be for example the name and the e-mail address of the user UT. At S20, the terminal TERu also receives personal data relating to the provider fᵢ in the background from the terminal TERfᵢ and according to a predefined configuration. According to this predefined configuration, these may be for example the name and an e-mail address of the provider fᵢ, as well as the visiting address of said provider. According to this predefined configuration, the personal data of the provider fᵢ that have been received are rendered on the terminal TERu, in text form, for example on the screen EC of the terminal TERu, or else in voice form, by way of the loudspeaker HP of the terminal TERu, at S21.

If, at S16, the user UT does not confirm the offer (“N” in FIG. 3), for example by pressing a dedicated button on the screen EC or by saying “NOT OK” via the microphone MIC, the ordering method returns to operation S13 with a view to selecting one of the remaining offers from among K−1. The selection is implemented through iteration in the order into which the offers have been sorted, an iteration being performed for as long as a new optimum offer is not selected. If none of the offers is accepted by the user UT, according to one exemplary embodiment, the connection established at S13 ends. The ordering method then returns to the entry operation S1, where the user UT is invited to enter additional information to that initially entered at S1. Operation S2 and the following operations are then reiterated. According to another exemplary embodiment, the connection established at S13 persists, and the ordering method returns to S10, where preconfigured adjustment variables are applied to:
all or some of the information contained in the request, and/or
an item of location data of the communication terminal, and/or
an item of time data associated with the request.

It goes without saying that the embodiments described above have been given purely by way of completely non-limiting indication, and that numerous modifications may be easily made by a person skilled in the art without, however, departing from the scope of the invention. Other applications of the invention are also possible, such as for example an electronic auction system or even a payment system via a mobile application downloaded onto a telecommunications terminal.

1. A secure communication method for ordering a product or a service by way of a communication terminal associated with a communication identifier (ICu), the method implemented by the terminal and comprising:
sending, to a server, via a communication network, a request containing information relating to a product or to a service,
establishing, in the background, communication to N terminals associated, respectively, with N communication identifiers, N being greater than or equal to 1, the N terminals being terminals of providers identified by the server as being able to provide the product or the service on the basis of all or some of the information contained in the request, said communication being established while masking the communication identifier of the terminal and the N communication identifiers,
during the communication, receiving an offer for a product or a service corresponding to said information from at least one provider terminal from among at least K, such that K is greater than or equal to one, and N is greater than or equal to K, the offer having been generated during the communication.

2. The method of claim 1, further comprising:
commanding the rendering of the offer on an interface of the terminal, the communication identifier of said at least one provider terminal and the identification of the provider of said at least one provider terminal being masked during the rendering.

3. The method of claim 1, wherein the method further comprises, upon acceptance of the offer:
sending identification data of the user of the terminal to said at least one provider terminal,
receiving identification data of a provider using said at least one provider terminal.

4. The method of claim 1, wherein the method further comprises, upon declination of the offer, continuing the communication, during which the actions of receiving an offer and of commanding the rendering of the received offer are iterated for as long as an offer is not accepted.

5. The method of claim 1, wherein the generated offer is selected so as to optimize a compromise between firstly all or some of the information contained in the request, and secondly an item of location data of the communication terminal and/or an item of time data associated with the request.

6. The method of claim 1, wherein, during the communication, the terminal receives, from respectively N-K product or service provider terminals identified by the server, N-K declinations to provide the product or the service corresponding to the request.

7. The method of claim 1, wherein the product or service offer received during the communication is generated taking into account at least one adjustment variable for:
all or some of the information contained in the request, and/or
an item of location data of the communication terminal, and/or
an item of time data associated with the request.

8. A secure communication terminal suitable for ordering a product or a service, said communication terminal being associated with a communication identifier and comprising a processor that is configured so as to implement the following:
sending, to a server, via a communication network, a request containing information relating to a product or to a service,
establishing, in the background, communication to N terminals associated, respectively, with N communication identifiers, N being greater than or equal to 1, the N terminals being terminals of providers identified by the server as being able to provide the product or the service on the basis of all or some of the information contained in the request, said communication being established while masking the communication identifier of the terminal and the N communication identifiers,
during the communication, receiving an offer for a product or a service corresponding to said information from at least one provider terminal from among at least K, such that K is greater than or equal to one, and N is greater than or equal to K, the offer having been generated during the communication.

9. A non-transitory computer readable medium having stored thereon instructions which, when executed by a processor, cause the processor to implement the method of claim 1.

10. A computer comprising a processor and a memory, the memory having stored thereon instructions which, when executed by the processor, cause the processor to implement the method of claim 1.
